(19) United States
(12) Patent Application Publication
(10) Pub. No.: US 2024/0161970 A1
(43) Pub. Date: May 16, 2024

(54) COIL COMPONENT

(71) Applicant: SAMSUNG ELECTRO-MECHANICS CO., LTD., Suwon-si (KR)

(72) Inventors: No Il PARK, Suwon-si (KR); In Young KANG, Suwon-si (KR); Jong Pil LEE, Suwon-si (KR)

(73) Assignee: SAMSUNG ELECTRO-MECHANICS CO., LTD., Suwon-si (KR)

(21) Appl. No.: 18/371,698

(22) Filed: Sep. 22, 2023

(30) Foreign Application Priority Data
Nov. 14, 2022 (KR) 10-2022-0151556

(51) Int. Cl. H01F 27/29; H01F 17/00; H01F 27/28

(52) U.S. Cl. CPC H01F 27/292; H01F 17/0013; H01F 27/2828

(57) ABSTRACT

A coil component includes: a body having a first and a second surface opposing, and including first and second recesses respectively formed in the first and the second surface; a support member disposed in the body; a coil including a first coil portion disposed on one surface of the support member, a sub-lead portion extending from an outermost turn of the first coil portion to the first surface, a first lead portion disposed on other surface of the support member and connected to the sub-lead portion, a second coil portion disposed on the other surface of the support member, and a second lead portion extending from an outermost turn of the second coil portion to the second surface, wherein a thickness of the sub-lead portion is less than that of the first coil portion, and a width of the sub-lead portion is less than that of the first lead portion.

### CROSS-REFERENCE TO RELATED APPLICATION(S)

This application claims benefit of priority to Korean Patent Application No. 10-2022-0151556 filed on Nov. 14, 2022 in the Korean Intellectual Property Office, the disclosure of which is incorporated herein by reference in its entirety.

### BACKGROUND

### 1. Technical Field

The present disclosure relates to a coil component.

### 2. Description of Related Art

An inductor, one of coil components, is a representative passive electronic component used in an electronic device together with a resistor and a capacitor.

As electronic devices gradually become more sophisticated and miniaturized, the number of electronic components used in electronic devices is also increased and their sizes are miniaturized.

Meanwhile, it may be advantageous for the coil component to have external electrodes disposed only on a mounting surface for integration thereof, and there is thus a demand for a coil component with less cracks and a larger effective volume while having such a lower surface electrode structure.

### SUMMARY

An aspect of the present disclosure may provide a coil component with a lower surface electrode structure that has a lower risk of cracks occurring in a dicing process.

Another aspect of the present disclosure may provide a coil component with a lower surface electrode structure that has a larger effective volume and a maintained coil resistance (or a direct current (DC) resistance Rd c).

According to an aspect of the present disclosure, a coil component may include: a body having a first surface and a second surface opposing each other in a first direction, a third surface and a fourth surface opposing each other in a second direction, and a fifth surface and a sixth surface opposing each other in a third direction, and including first and second recesses respectively disposed in the first surface and the second surface; a support member disposed in the body, and having one surface and the other surface opposing each other; a coil including a first coil portion disposed on the one surface of the support member and having at least one turn, a sub-lead portion extending from an outermost turn of the first coil portion to the first surface of the body, a first lead portion disposed on the other surface of the support member and connected to the sub-lead portion, a second coil portion disposed on the other surface of the support member and having at least one turn, and a second lead portion extending from an outermost turn of the second coil portion to the second surface of the body; a first external electrode disposed in the first recess, connected to the first lead portion, and extending to the sixth surface of the body; and a second external electrode disposed in the second recess, connected to the second lead portion, and extending to the sixth surface of the body, wherein a thickness of the sub-lead portion in the third direction is less than that of the first coil portion, and a width of the sub-lead portion in the second direction is less than that of the first lead portion.

According to an aspect of the present disclosure, a coil component may include: a body having a first surface and a second surface opposing each other in a first direction, and including a recess disposed in at least one of the first surface and the second surface; a support member disposed in the body, and having one surface and the other surface opposing each other; a coil including a first coil portion disposed on the one surface of the support member and having at least one turn, a sub-lead portion extending from an outermost turn of the first coil portion to the first surface of the body, a first lead portion disposed on the other surface of the support member and connected to the sub-lead portion, a second coil portion disposed on the other surface of the support member and having at least one turn, and a second lead portion extending from an outermost turn of the second coil portion to the second surface of the body; a first external electrode disposed in the recess, and connected to the first lead portion; and a second external electrode disposed on the body, and connected to the second lead portion, wherein a width of the sub-lead portion is less than that of the first lead portion.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view schematically illustrating a coil component according to a first exemplary embodiment of the present disclosure;

FIG. 2 is a view illustrating a cross-section taken along line I-I′ in FIG. 1;

FIG. 3 is a side view of the coil component of FIG. 1 that is viewed in a direction A;

FIG. 4 is a view illustrating a cross-section taken along line II-II′ in FIG. 1;

FIG. 5 is a view illustrating a cross-section taken along line in FIG. 1;

FIG. 6 is a perspective view schematically illustrating a coil component according to a second exemplary embodiment of the present disclosure; and

FIG. 7 is a view illustrating a cross-section taken along line IV-IV′ of FIG. 6.

### DETAILED DESCRIPTION

Hereinafter, exemplary embodiments of the present disclosure will now be described in detail with reference to the accompanying drawings.

In the drawings, an L direction refers to a first direction or length direction, a W direction refers to a second direction or width direction, and a T direction refers to a third direction or thickness direction.

Hereinafter, a coil component according to exemplary embodiments of the present disclosure will be described in detail with reference to the accompanying drawings. In describing the exemplary embodiments of the present disclosure with reference to the accompanying drawings, components that are the same as or correspond to each other will be denoted by the same reference numerals, and an overlapping description thereof will be omitted.

Various kinds of electronic components may be used in an electronic device, and various kinds of coil components may be appropriately used between these electronic components depending on their purposes in order to remove noise or the like.

That is, the coil component used in the electronic device may be a power inductor, high frequency (HF) inductor, a general bead, a bead for a high frequency (GHz), a common mode filter, or the like.

### First Exemplary Embodiment

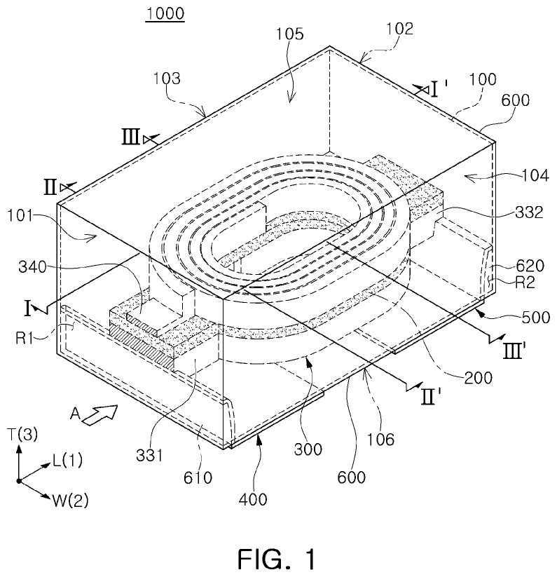

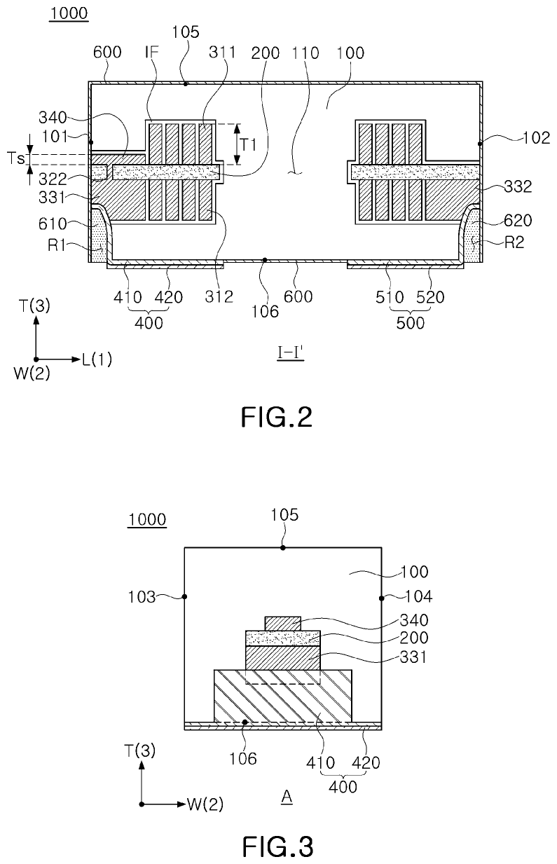

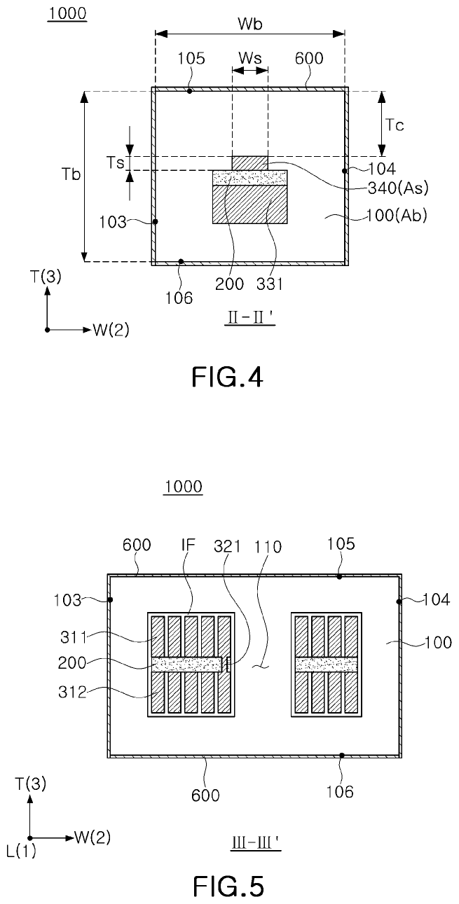

FIG. 1 is a perspective view schematically illustrating a coil component 1000 according to a first exemplary embodiment of the present disclosure; FIG. 2 is a view illustrating a cross-section taken along line I-I′ of FIG. 1; FIG. 3 is a side view of the coil component of FIG. 1 that is viewed in a direction A; FIG. 4 is a view illustrating a cross-section taken along line II-II′ of FIG. 1; and FIG. 5 is a view illustrating a cross-section taken along line III-III′ of FIG. 1.

Referring to FIGS. 1 through 3, the coil component 1000 according to a first exemplary embodiment of the present disclosure may include a body 100, a support member 200, a coil 300, and external electrodes 400 and 500, and may further include an insulating layer 600 covering the body 100.

The coil component 1000 according to this exemplary embodiment may secure a larger region where a magnetic material is disposed between a sub-lead portion 340 and a fifth surface 105 of the body 100 by making the width and thickness of the sub-lead portion 340 less to have the lower surface electrode structure. Accordingly, the coil component 1000 may have lower defects in which cracks occur in the body 100 in a dicing process for forming the first surface 101 of the body 100, a maintained coil resistance (or a direct current (DC) resistance R_{dc}) while having an improved inductance characteristic due to a larger effective volume.

Hereinafter, the description specifically describes the main components included in the coil component 1000 according to this exemplary embodiment.

The body 100 may form an appearance of the coil component 1000 according to this exemplary embodiment, and may embed the support member 200 and the coil 300.

The body 100 may generally have a hexahedral shape.

The body 100 may have a first surface and a second surface opposing each other in the length (L) direction or first direction, a third surface and a fourth surface opposing each other in the width (W) direction or second direction, and a fifth surface and a sixth surface opposing each other in the thickness (T) direction or third direction. Each of the first to fourth surfaces of the body 100 may correspond to a wall surface of the body 100 that connects the fifth and sixth surfaces of the body 100 to each other.

For example, the body 100 may be formed for the coil component 1000 according to this exemplary embodiment including the external electrodes 400 and 500 described below to have: a length of 2.5 mm, a width of 2.0 mm, and a thickness of 1.0 mm; a length of 2.0 mm, a width of 1.2 mm, and a thickness of 0.65 mm; a length of 1.6 mm, a width of 0.8 mm, and a thickness of 0.8 mm; a length of 1.4 mm, a width of 1.2 mm, and a thickness of 0.62 mm; a length of 1.0 mm, a width of 0.5 mm, and a thickness of 0.8 mm; or a length of 0.8 mm, a width of 0.4 mm, and a thickness of 0.65 mm. Meanwhile, the above exemplary dimensions for the length, width, and thickness of the coil component 1000 may be dimensions that do not reflect process errors, and a range of the dimensions recognized to include the process errors may thus fall within that of the above-described exemplary dimensions.

The above length of the coil component 1000 may indicate the maximum value of respective dimensions of a plurality of line segments spaced apart from each other in the thickness (T) direction, and connecting two outermost boundary lines opposing each other in the length (L) direction of the coil component 1000 shown in the following image to be parallel to the length (L) direction, based on the optical microscope image or scanning electron microscope (SEM) image of a cross-section of the coil component 1000 in a length (L)-thickness (T) direction that is taken from its center in the width (W) direction. Other methods and/or tools appreciated by one of ordinary skill in the art, even if not described in the present disclosure, may also be used. Alternatively, the length of the coil component 1000 may indicate the minimum value of the respective dimensions of the plurality of line segments described above. Alternatively, the length of the coil component 1000 may indicate an arithmetic average value of at least three of the respective dimensions of the plurality of line segments described above. Here, the plurality of line segments parallel to the length (L) direction may be equally spaced from each other in the thickness (T) direction, and the scope of the present disclosure is not limited thereto.

The above thickness of the coil component 1000 may indicate the maximum value of respective dimensions of a plurality of line segments spaced apart from each other in the length (L) direction, and connecting two outermost boundary lines opposing each other in the thickness (T) direction of the coil component 1000 shown in the following image to be parallel to the thickness (T) direction, based on the optical microscope image or scanning electron microscope (SEM) image of the cross-section of the coil component 1000 in the length (L)-thickness (T) direction that is taken from its center in the width (W) direction. Other methods and/or tools appreciated by one of ordinary skill in the art, even if not described in the present disclosure, may also be used. Alternatively, the thickness of the coil component 1000 may indicate the minimum value of the respective dimensions of the plurality of line segments described above. Alternatively, the thickness of the coil component 1000 may indicate an arithmetic average value of at least three of the respective dimensions of the plurality of line segments described above. Here, the plurality of line segments parallel to the thickness (T) direction may be equally spaced from each other in the length (L) direction, and the scope of the present disclosure is not limited thereto.

The above width of the coil component 1000 may indicate the maximum value of respective dimensions of a plurality of line segments spaced apart from each other in the length (L) direction, and connecting two outermost boundary lines opposing each other in the width (W) direction of the coil component 1000 shown in the following image to be parallel to the width (W) direction, based on the optical microscope image or scanning electron microscope (SEM) image of a cross-section of the coil component 1000 in a length (L)-width (W) direction that is taken from its center in the thickness (T) direction. Other methods and/or tools appreciated by one of ordinary skill in the art, even if not described in the present disclosure, may also be used. Alternatively, the width of the coil component 1000 may indicate the minimum value of the respective dimensions of the plurality of line segments described above. Alternatively, the width of the coil component 1000 may indicate an arithmetic average value of at least three of the respective dimensions of the plurality of line segments described above. Here, the plurality of line segments parallel to the width (W) direction may be equally spaced from each other in the length (L) direction, and the scope of the present disclosure is not limited thereto.

Alternatively, each of the length, width and thickness of the coil component 1000 may be measured using a micrometer measurement method. The micrometer measurement method may be used by setting a zero point with a micrometer using a repeatability and reproducibility (Gage R&R), inserting the coil component 1000 according to this exemplary embodiment between tips of the micrometer, and turning a measurement lever of the micrometer. Meanwhile, when measuring the length of the coil component 1000 by using the micrometer measurement method, the length of the coil component 1000 may indicate a value measured once or an arithmetic average of values measured several times. This method may be equally applied to measure the width or thickness of the coil component 1000.

The body 100 may include a magnetic material and resin. In detail, the body 100 may be formed by laminating one or more magnetic composite sheets in which the magnetic material is dispersed in the resin. However, the body 100 may also have a structure other than the structure in which the magnetic material is dispersed in the resin. For example, the body 100 may be made of the magnetic material such as ferrite.

The magnetic material may be the ferrite or metal magnetic powder particles.

The ferrite may be, for example, at least one of a spinel type ferrite such as Mg—Zn-based ferrite, Mn—Zn-based ferrite, Mn—Mg-based ferrite, Cu—Zn-based ferrite, Mg—Mn—Sr-based ferrite or Ni—Zn-based ferrite, a hexagonal type ferrite such as Ba—Zn-based ferrite, Ba—Mg-based ferrite, Ba—Ni-based ferrite, Ba—Co-based ferrite or Ba—Ni—Co-based ferrite, a garnet type ferrite such as Y-based ferrite, and Li-based ferrite.

The metal magnetic powder particles may include one or more selected from the group consisting of iron (Fe), silicon (Si), chromium (Cr), cobalt (Co), molybdenum (Mo), aluminum (Al), niobium (Nb), copper (Cu), boron (B), zirconium (Zr), hafnium (Hf), phosphorus (P), and nickel (Ni). For example, the metal magnetic powder particles may be one or more of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, and Fe—Cr—Al-based alloy powder particles.

The metal magnetic powder particles may be amorphous or crystalline. For example, the metal magnetic powder particles may be Fe—Si—B—Cr-based amorphous alloy powder particles, and are not necessarily limited thereto.

The ferrite and the metal magnetic powder particles may respectively have average diameters of about 0.1 μm to 30 μm, and are not limited thereto.

The body 100 may include two or more types of magnetic materials dispersed in the resin. Here, different types of magnetic materials may indicate that the magnetic materials dispersed in the resin are distinguished from each other by any one of an average diameter, a composition, crystallinity, and a shape.

The resin may include epoxy, polyimide, liquid crystal polymer (LCP), or the like, or mixtures thereof, and is not limited thereto.

The body 100 may include a core 110 passing through the support member 200 and the coil 300. The core 110 may be formed by filling a through-hole disposed in the support member 200 and the coil 300, with the magnetic composite sheet, and is not limited thereto.

Referring to FIGS. 1 and 2, recesses R1 and R2 may respectively be disposed in the first surface 101 and second surface 102 of the body 100.

In detail, the first recess R1 may be disposed in a region where the first surface 101 and sixth surface 106 of the body 100 meet each other, and the second recess R2 may be disposed in a region where the second surface 102 and sixth surface 106 of the body 100 meet each other.

The first recess R1 may extend to the third surface 103 and fourth surface 104 of the body 100 in the second or W direction. In addition, the second recess R2 may extend to the third surface 103 and fourth surface 104 of the body 100 in the second or W direction. However, the scope of the present disclosure is not limited thereto. For example, the recess R1 or R2 may extend to none of the third surface 103 and the fourth surface 104, and may be less than a width of the body 100 in the second or W direction.

Meanwhile, none of the recesses R1 and R2 may extend to the fifth surface 105 of the body 100. That is, none of the recesses R1 and R2 may pass through the body 100 in the third or T direction of the body 100.

The recess R1 or R2 may be formed by performing pre-dicing on one surface of a coil bar along a virtual boundary line matching the second or W direction of each coil component among the virtual boundary lines for individualizing each coil component in a level of the coil bar that indicates a state of each coil component before individualized. A depth of the pre-dicing may be adjusted for first and second lead portions 331 and 332 to be respectively exposed to the recesses R1 and R2.

An inner surface of the recess R1 or R2 may include an inner wall substantially parallel to the first or second surface 101 or 102 of the body 100, and a bottom surface connecting the inner wall and the first or second surface 101 or 102 of the body 100 to each other. However, the scope of the present disclosure is not limited thereto. For example, the inner surface of the first recess R1 may have a curved shape to connect the first and sixth surfaces 101 and 106 of the body 100 to each other on the L-T cross-section. In this case, the inner surface of the first recess R1 may not be distinguished from the above-mentioned inner wall and bottom surface. Alternatively, the inner surface may have an irregular shape.

The support member 200 may be disposed in the body 100, and have one surface and the other surface opposing each other. Based on directions shown in FIG. 1, one surface of the support member 200 may correspond to its upper surface, and the other surface of the support member 200 may correspond to its lower surface.

The support member 200 is a component supporting the coil 300. Referring to FIG. 2, the support member 200 may support a first coil portion 311 and the sub-lead portion 340, disposed on one surface, and a second coil portion 312 and the first and second lead portions 331 and 332, disposed on the other surface.

Meanwhile, the support member 200 may be excluded in some exemplary embodiments, such as a case where the coil 300 correspond to a wound coil or has a coreless structure.

The support member 200 may be made of an insulating material including thermosetting insulating resin such as epoxy resin, thermoplastic insulating resin such as polyimide, or photosensitive insulating resin, or may be made of an insulating material having a reinforcement material such as a glass fiber or an inorganic filler impregnated in the insulating resin. For example, the support member 200 may be made of a material such as prepreg, an Ajinomoto Build-up Film (ABF), FR-4, bismaleimide triazine (BT) resin, a photo imagable dielectric (PID) or a copper clad laminate (CCL), and is not limited thereto.

The inorganic filler may use one or more materials selected from the group consisting of silica (or silicon dioxide, SiO2), alumina (or aluminum oxide, Al₂O₃), silicon carbide (SiC), barium sulfate (BaSO₄), talc, clay, mica powder particles, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (A₁BO₃), barium titanate (BaTiO₃), and calcium zirconate (CaZrO₃).

Here, when made of the insulating material including the reinforcing material, the support member 200 may have more excellent rigidity. The support member 200 may be made of the insulating material including no glass fiber. In this case, an entire thickness of the support member 200 and the coil 300 (indicating sum of the respective dimensions of the coil 300 and the support member 200 in the third or T direction of FIG. 1) may be thinned, which is advantageous in reducing the thickness of the component. The support member 200 may be made of the insulating material including the photosensitive insulating resin. In this case, the number of processes for forming the coil 300 may be reduced, which is advantageous in reducing a production cost, and fine vias 321 and 322 may also be formed. For example, the support member 200 may have a thickness of 10 μm or more or 50 μm or less, and is not limited thereto.

The coil 300 may be embedded in the body 100 to express a characteristic of the coil component. For example, when the coil component 1000 of this exemplary embodiment is used as the power inductor, the coil 300 may store an electric field as a magnetic field to maintain an output voltage, thereby stabilizing power of the electronic device.

The coil 300 may include the first and second coil portions 311 and 312, the first and second lead portions 332 and 332, and the sub-lead portion 340, and may further include the first and second vias 321 and 322.

Referring to FIG. 2, based on directions shown in FIG. 2, the first coil portion 311 and the sub-lead portion 340 may be disposed on one surface (or the upper surface) of the support member 200 that faces the fifth surface 105 of the body 100, and the second coil portion 312, the second lead portion 332, and the first lead portion 331 may be disposed on the other surface (or the lower surface) of the support member 200 that faces the sixth surface 106 of the body 100.

Referring to FIGS. 1 and 2, the first coil portion 311 may be disposed on one surface of the support member 200 and have at least one turn wound around the core 110, and its outermost turn may extend to be in contact with the sub-lead portion 340. The first coil portion 311 may have a planar spiral shape, is not limited thereto, and may also have an angular shape.

The sub-lead portion 340 may be disposed on one surface of the support member 200 and extend from the outermost turn of the first coil portion 311 to the first surface 101 of the body 100. In detail, the sub-lead portion 340 may be disposed on one surface of the support member 200, exposed to the first surface 101 of the body 100, and covered by the insulating layer 600.

The sub-lead portion 340 may be connected to the first lead portion 331 disposed on the other surface of the support member 200 through the second via 322.

The first lead portion 331 may be disposed on the other surface of the support member 200 and spaced apart from the second coil portion 312, and exposed to the first surface 101 of the body 100 and the inner surface of the first recess R1 to be connected to the first external electrode 400.

At least a portion of the first lead portion 331 may extend into the first recess R1 to be in contact with the first external electrode 400. In addition, at least a portion of the first lead portion 331 may be removed along with a part of the body 100 in a process for forming the first recess R1. Therefore, at least a portion of the first lead portion 331 may be coplanar with an outer surface of the first recess R1.

The second coil portion 312 may be disposed on the other surface of the support member 200 and have at least one turn wound around the core 110, and its outermost turn may extend to be in contact with the second lead portion 332. The second coil portion 312 may have a planar spiral shape, is not limited thereto, and may also have an angular shape. The second lead portion 332 may be disposed on the lower surface of the support member 200, and exposed to the second surface 102 of the body 100 and the inner surface of the second recess R2 to be connected to the second external electrode 500.

At least a portion of the second lead portion 332 may extend into the second recess R2 to be in contact with the second external electrode 500. In addition, at least a portion of the second lead portion 332 may be removed along with a part of the body 100 in a process for forming the second recess R2. Therefore, at least a portion of the second lead portion 332 may be coplanar with an outer surface of the second recess R2.

Meanwhile, this exemplary embodiment has an asymmetric structure in which the sub-lead portion 340 is disposed only on the first surface 101 of the body 100, is not limited thereto, and may further include another sub-lead portion disposed on one surface of the support member 200, connected to the second lead portion 332 on the other surface of the support member 200, and exposed to the second surface 102 of the body 100. However, when the sub-lead portion 340 is disposed only on one surface of the body 100 asymmetrically as in this exemplary embodiment, an effective volume of the body 100 may be increased to improve an inductance characteristic of the coil component.

Referring to FIGS. 2 and 4, a thickness Ts of the sub-lead portion 340 in the third or T direction may be less than a thickness T1 of the first coil portion 311 in the third or T direction. In addition, a width Ws of the sub-lead portion 340 in the second or W direction may be less than a width W1 of the first lead portion 331 in the second or W direction.

Here, the thickness Ts of the sub-lead portion 340 in the third or T direction may indicate an arithmetic average value of at least three of respective dimensions of a plurality of line segments spaced apart from each other in the first or L direction, and connecting two outermost boundary lines opposing each other in the third or T direction of the sub-lead portion 340 shown in the following image to be parallel to the third or T direction, based on the optical microscope image or scanning electron microscope (SEM) image of a L-T cross-section of the coil component 1000 that is taken from its center in the second or W direction. Other methods and/or tools appreciated by one of ordinary skill in the art, even if not described in the present disclosure, may also be used. The plurality of line segments parallel to the third or T direction may be equally spaced from each other in the first or L direction, and the scope of the present disclosure is not limited thereto.

Meanwhile, the thickness T1 of the first coil portion 311 in the third or T direction may also be defined similarly to the above.

In addition, the width Wₛ of the sub-lead portion 340 in the second or W direction may indicate an arithmetic average value of at least three of respective dimensions of a plurality of line segments spaced apart from each other in the third or T direction, and connecting two outermost boundary lines opposing each other in the second or W direction of the sub-lead portion 340 shown in the following image to be parallel to the second or W direction, based on the optical microscope image or scanning electron microscope (SEM) image of a W-T cross-section of the coil component 1000 that exposes the sub-lead portion 340 by being polished from the first surface 101 of the body 100 to its portion more inward than the first recess R1 in the first or L direction. Other methods and/or tools appreciated by one of ordinary skill in the art, even if not described in the present disclosure, may also be used. The plurality of line segments parallel to the second or W direction may be equally spaced from each other in the third or T direction, and the scope of the present disclosure is not limited thereto.

Meanwhile, the width W1 of the first lead portion 331 in the second or W direction may also be defined similarly to the above.

FIG. 3 is a left side view of the coil component of FIG. 1 that is viewed in the direction A. Meanwhile, the drawings omit the insulating layer 600 disposed on an outer surface of the body 100 to more clearly show a disposition relationship between the components.

Referring to FIG. 3, in the coil component 1000 according to this exemplary embodiment, the support member 200, the sub-lead portion 340 disposed on one surface of the support member 200, and the first lead portion 331 disposed on the other surface of the support member 200 may extend to the first surface 101 of the body 100. In detail, the support member 200 and the sub-lead portion 340 disposed on one surface of the support member 200 may be exposed to the first surface 101 of the body 100, and at least a portion of the first lead portion 331 disposed on the other surface of the support member 200 may be exposed to the first recess R1 disposed in the first surface 101 of the body 100. Here, the first external electrode 400 may extend to the first recess R1 to cover at least a portion of the first lead portion 331, and the insulating layer 600 may cover the first surface 101 of the body 100 and at least a portion of the first external electrode 400.

Meanwhile, the sub-lead portion 340 may have a larger area exposed to the first surface 101 of the body 100. In this case, the crack may occur on an upper surface of the body 100 that covers the sub-lead portion 340 in the dicing process, and the magnetic material may have a smaller effective volume as a volume of the sub-lead portion 340 in the body 100 is larger.

Accordingly, this exemplary embodiment may solve the above-mentioned problems by making the exposed area and volume of the sub-lead portion 340 smaller.

Referring to FIG. 4, a ratio Tc/Ts of a thickness Tc of the body 100 in the third or T direction between the sub-lead portion 340 and the fifth surface 105 of the body 100 to a thickness Ts of the sub-lead portion 340 in the third or T direction may be 1.15 or more and 6 or less.

For non-limiting example, when the thickness of the body 100 in the third or T direction is 0.62 mm, the thickness Tc of the body 100 in the third or T direction between the sub-lead portion 340 and the fifth surface 105 of the body 100 may be 0.15 mm or more and 0.24 mm or less.

In a process of dicing the coil components into individual components in a coil bar state, the crack is highly likely to occur in a region between the fifth surface 105 of the body 100 and a corner where the upper surface and side surface of the sub-lead portion 340 meet each other. Therefore, it is possible to lower the risk of crack occurring in a coil component of the same size by reducing the thickness Ts of the sub-lead portion 340 in the third or T direction and increasing the thickness Tc of the magnetic material covering an upper part region of the sub-lead portion 340 as much as the reduced thickness Ts.

Referring to FIG. 4, a ratio Ab/As of a cross-sectional area Ab of the body 100 to a cross-sectional area As of the sub-lead portion 340 may be 28.6 or more and 93 or less, based on a W-T cross-section of the coil component 1000 that is perpendicular to the first or L direction, disposed more inward than the first or second recess R1 or R2, and including the sub-lead portion 340. Here, the cross-sectional area Ab of the body 100 may be acquired by multiplying a width Wb of the body 100 in the second or W direction by a thickness Tb of the body 100 in the third or T direction. That is, the cross-sectional area Ab of the body 100 on the W-T cross-section may be the cross-sectional area of the entire body 100 that includes those of the sub-lead portion 340, the support member 200, and the first lead portion 331, exposed on the W-T cross-section. The cross-sectional area As may be acquired by multiplying a width of the sub-lead portion 340 in the second or W direction by a thickness Ts of the sub-lead portion 340 in the third or T direction.

Table 1 below shows experimental data on whether a crack defect occurs and coil resistance R_{dc} is increased, based on a change in the thickness Ts and cross-sectional area As of the sub-lead portion 340. This experiment is conducted on 10 samples of coil components each having a length of 1.4 mm, a width of 1.2 mm, and a thickness of 0.62 mm. Therefore, the experiment is conducted while the cross-sectional area Ab of the first surface 101 of the body 100 is fixed to 0.744 mm² (1.2 (W)×0.62 (T)). The crack defect may be defined as if at least one sample with a crack is observed in the body 100, based on the optical microscope image or scanning electron microscope (SEM) image of the W-T cross-section in which the sub-lead portion 340 is shown.

Meanwhile, the experiment is conducted on a cross-sectional area of the first coil portion 311 based on the L-T cross-section of the of coil component 1000 that is taken from its center in the second or W direction while the cross-sectional area of a turn of the first coil portion 311 that is most adjacent to the sub-lead portion 340 is fixed to 0.005 mm² (0.15 (W)×0.035 (L)).

TABLE 1

| | | | | Cross- | | | |
|---|---|---|---|---|---|---|---|
| | | Thickness | | sectional | | | |
| | Thickness | (Ts, mm) | | area | | | |
| | (Tc, mm) | of sub- | | (As, mm²) | | | R_{dc} |
| Experimental | of cover | lead | | of sub-lead | | Crack | increase |
| example | part | portion | Tc/Ts | portion | Ab/As | occurrence | or not |
| #1 | 0.13 | 0.15 | 0.86 | 0.060 | 12.4 | Positive | Maintained |
| #2 | 0.14 | 0.14 | 1.00 | 0.028 | 26.5 | Positive | Maintained |
| #3 | 0.15 | 0.13 | 1.15 | 0.026 | 28.6 | Negative | Maintained |
| #4 | 0.16 | 0.12 | 1.33 | 0.024 | 31.0 | Negative | Maintained |
| #5 | 0.17 | 0.11 | 1.54 | 0.022 | 33.8 | Negative | Maintained |
| #6 | 0.18 | 0.10 | 1.80 | 0.020 | 37.2 | Negative | Maintained |
| #7 | 0.20 | 0.08 | 2.50 | 0.016 | 46.5 | Negative | Maintained |
| #8 | 0.22 | 0.06 | 3.66 | 0.012 | 62.0 | Negative | Maintained |
| #9 | 0.24 | 0.04 | 6.00 | 0.008 | 93.0 | Negative | Maintained |
| #10 | 0.26 | 0.02 | 13.0 | 0.004 | 186 | Negative | Increased |

Referring to Table 1, in the coil component 1000 according to this exemplary embodiment, no crack defect occurs when the ratio Tc/Ts of the thickness Tc of the cover part to the thickness Ts of the sub-lead portion 340 is 1.15 or more. Here, the cover part may be a magnetic region covering an upper part of the coil 300, and the thickness of the cover part may be defined as the thickness Tc of the body 100 in the third or T direction between the sub-lead portion 340 and the fifth surface 105 of the body 100.

Here, the thickness Tc of the body 100 in the third or T direction between the sub-lead portion 340 and the fifth surface 105 of the body 100 may indicate an arithmetic average value of at least three of respective dimensions of a plurality of line segments spaced apart from each other in the second or W direction, and connecting the outermost boundary line of the upper surface of the sub-lead portion 340 shown in the following image with the fifth surface 105 of the body 100 to be parallel to the third or T direction, based on the optical microscope image or scanning electron microscope (SEM) image of the W-T cross-section of the coil component 1000 that exposes the sub-lead portion 340 by being polished from the first surface 101 of the body 100 to its portion more inward than the first recess R1 in the first or L direction. Other methods and/or tools appreciated by one of ordinary skill in the art, even if not described in the present disclosure, may also be used. The plurality of line segments parallel to the third or T direction may be equally spaced from each other in the second or W direction, and the scope of the present disclosure is not limited thereto.

Referring back to FIG. 1, no crack defect occurs when the ratio Ab/As of the cross-sectional area Ab of the body 100 to the cross-sectional area As of the sub-lead portion 340 may be 28.6 or more based on the W-T cross-section of the coil component 1000 that is perpendicular to the first or L direction, disposed more inward than the first or second recess R1 or R2, and including the sub-lead portion 340. Here, the cross-sectional area Ab of the body 100 may be acquired by multiplying the width Wb of the body 100 in the second or W direction by the thickness Tb of the body 100 in the third or T direction.

Meanwhile, a side effect of increasing the coil resistance component R_{dc} may occur when a volume of the sub-lead portion 340 is reduced to a certain level. Here, when the cross-sectional area As of the sub-lead portion 340 is less than a cross-sectional area of the outermost turn of the adjacent first coil portion 311 (that is fixed to 0.005 mm² (0.15 (W)×0.035 (L)) in this experimental example), a bottleneck phenomenon may occur in a current flow to thus increase the coil resistance component R_{dc}, thereby lowering a R_{dc} characteristic of the coil component 1000.

Referring to Table 1, the R_{dc} characteristic may be lower as the thickness Ts of the sub-lead portion 340 is reduced when the ratio Tc/Ts of the thickness Tc of the cover part to the thickness Ts of the sub-lead portion 340 is more than 6.00.

In addition, the R_{dc} characteristic may be lower when the ratio Ab/As of the cross-sectional area Ab of the body 100 to the cross-sectional area As of the sub-lead portion 340 is more than 93.0 based on the W-T cross-section of the coil component 1000 that is perpendicular to the first or L direction, disposed more inward than the first or second recess R1 or R2, and including the sub-lead portion 340.

Therefore, taking the above experimental results together, the ratio Tc/Ts of the thickness Tc of the body 100 in the third or T direction between the sub-lead portion 340 and the fifth surface 105 of the body 100 to the thickness Ts of the sub-lead portion 340 in the third or T direction may be 1.15 or more and 6 or less.

In addition, the ratio Ab/As of the cross-sectional area Ab of the body 100 to the cross-sectional area As of the sub-lead portion 340 may be 28.6 or more and 93.0 or less based on the W-T cross-section of the coil component 1000 that is perpendicular to the first or L direction, disposed more inward than the first or second recess R1 or R2, and including the sub-lead portion 340.

When having a ratio within the above-described range, the coil component 1000 may have the maintained R_{dc} characteristic while having a lower crack defect rate.

Referring to FIG. 5, the first via 321 may connect the first and second coil portions 311 and 312 disposed on both the surfaces of the support member 200 to each other. In detail, the first via 321 may pass through the support member 200 to thus connect ends of the innermost turns of the first and second coils portions 311 and 312 to each other.

In addition, referring to FIG. 2, the second via 322 may connect the sub-lead portion 340 and the first lead portion 331 disposed on both the surfaces of the support member 200 to each other. In detail, the second via 322 may pass through the support member 200 to thus connect the sub-lead portion 340 and the first lead portion 331 to each other.

Accordingly, a signal input to the first external electrode 400 may be output to the second external electrode 500 through the first lead portion 331, the second via 322, the sub-lead portion 340, the first coil portion 311, the first via 321, the second coil portion 312, and the second lead portion 332. Through this structure, the respective components of the coil 300 may function as one coil connected between the first and second external electrodes 400 and 500.

At least one of the first and second coil portions 311 and 312, the first and second vias 322 and 322, the first and second lead portions 331 and 332, and the sub-lead portion 340 may include at least one conductive layer. For example, the first coil portion 311, the first lead portion 331, and the first via 321 may be plated on the upper surface of the support member 200. In this case, each of the first coil portion 311, the first lead portion 331, and the first via 321 may include a first conductive layer formed by electroless plating or the like, and a second conductive layer disposed on the first conductive layer.

The first conductive layer may be a seed layer for plating the second conductive layer on the support member 200, and the second conductive layer may be an electroplating layer. Here, the electroplating layer may have a single-layer or multilayer structure. The electroplating layer having the multilayer structure may be a conformal film in which another electroplating layer covers one electroplating layer, or may be a layer in which another electroplating layer is laminated on only one surface of one electroplating layer. The seed layer of the first coil portion 311 and the seed layer of the first lead portion 331 may be integrally formed to thus have no boundary therebetween, and are not limited thereto. The electroplating layer of the first coil portion 311 and the electroplating layer of the first lead portion 331 may be integrally formed to thus have no boundary therebetween, and are not limited thereto.

Each of the first and second coil portions 311 and 312, the first and second vias 321 and 322, the first and second lead portions 331 and 332, and the sub-lead portion 340 may be made of a conductive material such as copper (Cu), aluminum (Al), silver (Ag), tin (Sn), gold (Au), nickel (Ni), lead (Pb), titanium (Ti), or an alloy thereof, and is not limited thereto.

Referring to FIGS. 2 and 5, the coil component 1000 according to this exemplary embodiment may further include an insulating film IF disposed in the body 100.

The insulating film IF may insulate the coil portions 311 and 312, the lead portions 331 and 332, and the sub-lead portion 340 from the body 100. The insulating film IF may include, for example, parylene, and is not limited thereto. The insulating film IF may be formed by a vapor deposition method or the like, is not limited thereto, and may be formed by laminating insulating films on both the surfaces of the support member 200. Meanwhile, the insulating film IF may include a portion of a plating resist used in forming the coil 300 by electroplating, and is not limited thereto.

Referring to FIG. 2, the first and second external electrodes 400 and 500 may be disposed on the sixth surface 106 of the body 100 while being spaced apart from each other, and respectively extend to the first and second recesses R1 and R2 to be connected to the first lead portion 331 and the second lead portion 332.

Each of the first and second external electrodes 400 and 500 may include a connection part disposed in the recess R1 or R2 and connected to the first lead portion 331 or the second lead portion 332, and a pad part extending from the connection part to the sixth surface 106 of the body 100. The connection part and the pad part may be integrally formed with each other, and are not limited thereto.

The pad part of the external electrode 400 or 500 may be in contact with a connection member such as solder when the coil component 1000 is mounted on a printed circuit board, and protrude from the sixth surface 106 of the body 100 to be beyond the insulating layer 600 described below. The pad part of the external electrode 400 or 500 may protrude as in this exemplary embodiment. In this case, when mounted on the printed circuit board, the coil component 1000 may have a higher adhesion strength due to an increased contact area of the coil component with the connection member such as the solder, and have a lower risk of short circuit due to an increased gap of the coil component with the board.

The external electrode 400 or 500 may be integrally disposed on the inner surface of the recess R1 or R2 and the sixth surface 106 of the body 100. For example, the external electrode 400 or 500 may be a conformal film disposed on the inner surface of the recess R1 or R2 and the sixth surface 106 of the body 100. In this case, the external electrode 400 or 500 may be formed by a thin film process such as a sputtering process or a plating process.

The external electrode 400 or 500 may be made of a conductive material such as copper (Cu), aluminum (Al), silver (Ag), tin (Sn), gold (Au), nickel (Ni), lead (Pb), chromium (Cr), titanium (Ti), or an alloy thereof, and is not limited thereto.

Referring to FIGS. 2 and 3, the external electrode 400 or 500 may have the multilayer structure. For example, a first layer 410 or 510 of the external electrode 400 or 500 that is connected to the coil 300 may be a conductive resin layer including a conductive powder including at least one of copper (Cu) and silver (Ag) and the insulating resin, or may be a copper (Cu) plating layer. In addition, a second layer 420 or 520 may have a double layer structure of a nickel (Ni) plating layer and a tin (Sn) plating layer.

The first layer 410 or 510 may be made by the electroplating, the vapor deposition such as the sputtering, or by applying and curing a conductive paste including the conductive powder such as copper (Cu) and/or silver (Ag), and the second layer 420 or 520 may be made by the electroplating.

The coil component 1000 according to this exemplary embodiment may further include an insulating layer covering the body 100 and exposing the first and second external electrodes 400 and 500 disposed on the sixth surface 106 of the body 100.

Referring to FIGS. 1, 2, 4, and 5, the insulating layer 600 may cover the first to sixth surfaces 101, 102, 103, 104, 105, and 106 of the body 100, and expose the first and second external electrodes 400 and 500 disposed on the sixth surface 106 of body 100. In addition, the insulating layer may cover regions of the external electrodes 400 and 500, disposed in the recesses R1 and R2 in the first surface 101 and second surface 102 of body 100, or filling portions 610 and 620 described below.

Meanwhile, the insulating layer 600 of this exemplary embodiment may be thinner than the external electrode 400 or 500 on the sixth surface 106 of the body 100. In this case, the external electrode 400 or 500 may protrude to a mounting surface. That is, an outer surface of the second layer 420 or 520 may protrude beyond an outer surface of the insulating layer 600.

The external electrode 400 or 500 may protrude beyond insulating layer 600 as in this exemplary embodiment. In this case, when mounted on the printed circuit board, the coil component 1000 may have the higher adhesion strength due to the increased contact area of the coil component with the connection member such as the solder, and have the lower risk of short circuit due to the increased gap of the coil component with the board.

The insulating layer 600 may be formed, for example, by coating and curing an insulating material including the insulating resin on the surface of the body 100. In this case, the insulating layer 600 may include at least one of thermoplastic resin such as polystyrene-based resin, vinyl acetate-based resin, polyester-based resin, polyethylene-based resin, polypropylene-based resin, polyamide-based resin, rubber-based resin, acrylic resin, thermosetting resin such as phenol-based resin, epoxy-based resin, urethane-based resin, melamine-based resin, and alkyd-based resin, and the photosensitive insulating resin.

Meanwhile, referring to FIG. 2, the coil component 1000 according to this exemplary embodiment may further include the filling portions 610 and 620 respectively disposed between the recesses R1 and R2 and the insulating layer 600.

The filling portion 610 or 620 may improve the appearance of the coil component 1000 by filling an edge region depressed due to formation of the recess R1 or R2, and also improve a printing quality of the insulating layer 600.

In this exemplary embodiment, the first and second filling portions 610 and 620 cover the external electrodes 400 and 500 respectively disposed in the recesses R1 and R2.

The filling portion 610 or 620 may have side surfaces substantially coplanar with some of the first to fourth surfaces 101, 102, 103, and 104 of the body 100. That is, the first filling portion 610 may have the side surfaces substantially coplanar with the first, third, and fourth surfaces 101, 103, and 104 of the body 100, and the second filling portion 620 may have the side surfaces substantially coplanar with the second, third, and fourth surfaces 102, 103, and 104 of the body 100. Here, substantially coplanar may indicate that two parts may share substantially the same plane, including the process error.

The filling portion 610 or 620 may be formed on the external electrode 400 or 500 disposed in the recess R1 or R2 by using a printing method, the vapor deposition method, a spray coating method, a film laminating method, or the like, and is not limited thereto. The filling portion 610 or 620 may include thermoplastic resin such as polystyrene-based resin, vinyl acetate-based resin, polyester-based resin, polyethylene-based resin, polypropylene-based resin, polyamide-based resin, rubber-based resin, acrylic resin, thermosetting resin such as phenol-based resin, epoxy-based resin, urethane-based resin, melamine-based resin, and alkyd-based resin, and the photosensitive resin, parylene, silicon dioxide (SiOx), or silicon nitride (SiNx).

The filling portion 610 or 620 may be omitted in this exemplary embodiment. In this case, the thicker insulating layer 600 may be disposed in a region where the filling portion 610 or 620 is to disposed, and is not limited thereto.

### Second Exemplary Embodiment

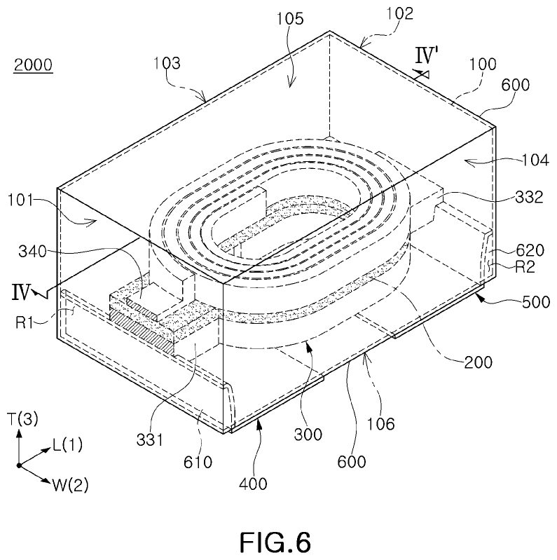

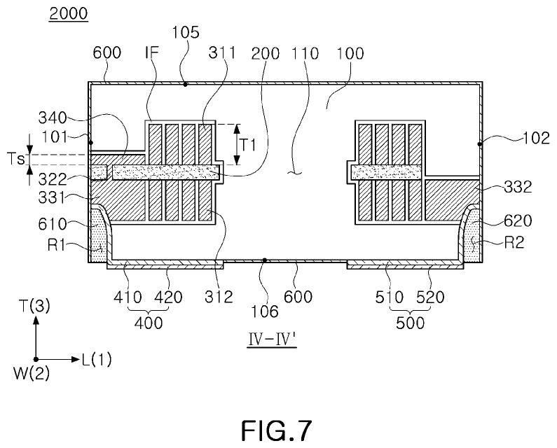

FIG. 6 is a perspective view schematically illustrating a coil component 2000 according to a second exemplary embodiment of the present disclosure; and FIG. 7 is a view illustrating a cross-section taken along line IV-IV′ of FIG. 6.

Referring to FIGS. 6 and 7, when compared to a first exemplary embodiment, this exemplary embodiment is different therefrom in removal of a partial region of the support member 200 that is exposed to the second surface 102 of the body 100 and supporting the second lead portion 332, and a disposition relationship between the second lead portion 332 and the insulating film IF.

Therefore, in describing this exemplary embodiment, the support member 200, and the disposition relationship between the second lead portion 332 and the insulating film IF, which are different from those in a first exemplary embodiment of the present disclosure, are only described, and the descriptions of the other components in a first exemplary embodiment of the present disclosure may be equally applied to descriptions of those in this exemplary embodiment.

Referring to FIGS. 6 and 7, the support member 200 of the coil component 2000 according to this exemplary embodiment may be spaced apart from the second surface 102 of the body 100.

Unlike a region of the support member 200 that is adjacent to the first surface 101 of the body 100, its region adjacent to the second surface 102 of the body 100 may not require formation of the second via 322. Accordingly, the partial region of the support member 200 may be removed by a laser or the like after disposing the second lead portion 332. In this case, an upper surface of the second lead portion 332 may be covered by the insulating film IF to be insulated from the body 100.

The support member 200 may be partially removed as in this exemplary embodiment. In this case, it is possible to further secure a more space for filling the magnetic material in a coil component of the same size when compared to the case of reducing only the volume of the sub-lead portion 340, thereby further improving the inductance characteristic due to the larger effective volume.

As set forth above, according to one aspect of the present disclosure, it is possible to provide the coil component with the lower surface electrode structure that has the lower risk of cracks occurring in the dicing process.

According to another aspect of the present disclosure, it is possible to provide the coil component with the lower surface electrode structure that has the larger effective volume and the maintained coil resistance (or the direct current (DC) resistance R_{dc}).

While the exemplary embodiments have been shown and described above, it will be apparent to those skilled in the art that modifications and variations could be made without departing from the scope of the present disclosure as defined by the appended claims.

What is claimed is:

1. A coil component comprising:
a body having a first surface and a second surface opposing each other in a first direction, a third surface and a fourth surface opposing each other in a second direction, and a fifth surface and a sixth surface opposing each other in a third direction, and including first and second recesses respectively disposed in the first surface and the second surface;
a support member disposed in the body, and having one surface and the other surface opposing each other;
a coil including:
a first coil portion disposed on the one surface of the support member and having at least one turn,
a sub-lead portion extending from an outermost turn of the first coil portion to the first surface of the body,
a first lead portion disposed on the other surface of the support member and connected to the sub-lead portion,
a second coil portion disposed on the other surface of the support member and having at least one turn, and
a second lead portion extending from an outermost turn of the second coil portion to the second surface of the body;
a first external electrode disposed in the first recess, connected to the first lead portion, and extending to the sixth surface of the body; and
a second external electrode disposed in the second recess, connected to the second lead portion, and extending to the sixth surface of the body,
wherein a thickness of the sub-lead portion in the third direction is less than that of the first coil portion, and a width of the sub-lead portion in the second direction is less than that of the first lead portion.

2. The coil component of claim 1, wherein a ratio Tc/Ts of a thickness Tc of the body in the third direction between the sub-lead portion and the fifth surface of the body to a thickness Ts of the sub-lead portion in the third direction is 1.15 or more and 6 or less.

3. The coil component of claim 2, wherein the thickness Tc of the body in the third direction between the sub-lead portion and the fifth surface of the body is 0.15 mm or more and 0.24 mm or less.

4. The coil component of claim 1, wherein a ratio Ab/As of a cross-sectional area Ab of the body to a cross-sectional area As of the sub-lead portion is 28.6 or more and 93 or less, based on a cross-section of the coil component that is perpendicular to the first direction, disposed more inward than the first or second recess, and including the sub-lead portion.

5. The coil component of claim 4, wherein the cross-sectional area Ab of the body is acquired by multiplying a width Wb of the body in the second direction by a thickness Tb of the body in the third direction.

6. The coil component of claim 2, wherein a ratio Ab/As of a cross-sectional area Ab of the body to a cross-sectional area As of the sub-lead portion is 28.6 or more and 93 or less, based on a cross-section of the coil component that is perpendicular to the first direction, disposed more inward than the first or second recess, and including the sub-lead portion.

7. The coil component of claim 1, wherein the support member is spaced apart from the second surface of the body.

8. The coil component of claim 1, wherein the coil further includes a first via connecting the first coil portion and the second coil portion to each other, and a second via connecting the sub-lead portion and the first lead portion to each other.

9. The coil component of claim 8, wherein at least one of the first and second vias passes through the support member.

10. The coil component of claim 1, wherein the first recess is disposed in a region where the first surface and sixth surface of the body meet each other, and
the second recess is disposed in a region where the second surface and sixth surface of the body meet each other.

11. The coil component of claim 10, wherein each of the first and second recesses extends to the third surface and fourth surface of the body in the second direction.

12. The coil component of claim 1, wherein at least a portion of the first lead portion extends into the first recess to be in contact with the first external electrode, and
at least a portion of the second lead portion extends into the second recess to be in contact with the second external electrode.

13. The coil component of claim 1, wherein at least a portion of the first lead portion is coplanar with an outer surface of the first recess, and
at least a portion of the second lead portion is coplanar with an outer surface of the second recess.

14. The coil component of claim 1, further comprising an insulating layer covering the body and exposing the first and second external electrodes disposed on the sixth surface of the body.

15. A coil component comprising:
a body having a first surface and a second surface opposing each other in a first direction, and including a recess disposed in at least one of the first surface and the second surface;
a support member disposed in the body, and having one surface and the other surface opposing each other;
a coil including:
a first coil portion disposed on the one surface of the support member and having at least one turn,
a sub-lead portion extending from an outermost turn of the first coil portion to the first surface of the body,
a first lead portion disposed on the other surface of the support member and connected to the sub-lead portion,
a second coil portion disposed on the other surface of the support member and having at least one turn, and
a second lead portion extending from an outermost turn of the second coil portion to the second surface of the body;
a first external electrode disposed in the recess, and connected to the first lead portion,
a second external electrode disposed on the body and connected to the second lead portion,
wherein a width of the sub-lead portion is less than that of the first lead portion.

16. The coil component of claim 15, wherein a thickness of the sub-lead portion is less than that of the first coil portion.

17. The coil component of claim 15, wherein the support member is spaced apart from the second surface of the body.

18. The coil component of claim 15, wherein the coil further includes a first via connecting the first coil portion and the second coil portion to each other, and a second via connecting the sub-lead portion and the first lead portion to each other.
